(19) United States
(12) Patent Application Publication
(10) Pub. No.: US 2012/0155671 A1
(43) Pub. Date: Jun. 21, 2012

(54) INFORMATION PROCESSING APPARATUS, METHOD, AND PROGRAM AND INFORMATION PROCESSING SYSTEM

(76) Inventor: Mitsuhiro SUZUKI, Tokyo (JP)

(21) Appl. No.: 13/312,737

(22) Filed: Dec. 6, 2011

(30) Foreign Application Priority Data
Dec. 15, 2010 (JP) P2010-279510

(51) Int. Cl. H04B 3/00

(52) U.S. Cl. 381/77

(57) ABSTRACT

An information processing apparatus includes a reproduction control unit controlling reproduction of a content item; a reception unit receiving reaction sound data stored in UDP packets and transmitted from a server via a communication network when reproducing the content item, the server generating the reaction sound data of reaction sounds by receiving sound data obtained by receiving sounds produced as reactions to the content item from users from a plurality of apparatuses via the communication network, performing sound processing on the plurality of sound data received from the apparatuses based on positions of the users at a single virtual site and acoustic characteristics of the site, and adding the plurality of sound data subjected to the sound processing; and a sound output unit outputting the reaction sounds based on the received reaction sound data when the content item is reproduced.

### BACKGROUND

The present disclosure relates to an information processing apparatus, method, and program and an information processing system, and more particularly, to an information processing apparatus, method, and program and an information processing system capable of making users aware of the reactions from many other users for a content item in real time irrespective of a content item.

Hitherto, there has been known public viewing in which a large-size display apparatus is installed in a stadium or in the street so as to allow watching of images of sports or the like. In the public viewing, many users can watch a content item at the same place and share feelings such as impressions of each scene of the content item in real time.

However, content items for such public viewing are limited to, for example, specific content items such as the soccer World Cup. Therefore, in regard to most of the other content items, users may not know reactions from other users located at the other places watching the content items in real time, and thus do not share the feelings for each scene. Further, when public viewing is held, the users have to go to the site of the public viewing. Therefore, it is inconvenient to enjoy the public viewing.

Since mobile phones have a bi-directional communication function, there have been suggested many techniques for using the bi-directional communication function. For example, as one of the techniques, there has been suggested a counseling system which heals the mind of a user by accessing a reception station through a mobile phone, and then receiving and reproducing a moving image or a sound in response to a sound produced by the user (for example, see Japanese Unexamined Patent Application Publication No. 2006-31090).

### SUMMARY

When character data or sound data input to the reception station by other users are recorded using the bi-directional communication function, it is considered that users can know the reactions of the other users for a content item, which the users are watching, by acquiring and reproducing the data.

In the above-described technique, however, the users have to acquire and reproduce data regarding characters or the like input by the other users one by one in accordance with a guide of the reception station, and thus the operation is troublesome. That is, the characters or sounds input by a plurality of users may not be simultaneously reproduced. For this reason, when watching a content item, the users may not simultaneously know the reactions of the many other users located at other places in real time, and thus may not share the feelings of the other users for each scene of the content item.

It is desirable to provide an information processing apparatus, method, and program and an information processing system capable of making users aware of reactions to a content item from many other users in real time irrespective of the content item.

According to an embodiment of the disclosure, there is provided an information processing apparatus including: a reproduction control unit controlling reproduction of a content item; a reception unit receiving reaction sound data stored in UDP packets and transmitted from a server via a communication network when reproducing the content item, the server generating the reaction sound data of reaction sounds by receiving sound data obtained by receiving sounds produced as reactions to the content item from users from a plurality of apparatuses via the communication network, performing sound processing on the plurality of sound data received from the apparatuses based on positions of the users at a single virtual site and acoustic characteristics of the site, and adding the plurality of sound data subjected to the sound processing; and a sound output unit outputting the reaction sounds based on the received reaction sound data when the content item is reproduced.

The information processing apparatus may further include a sound reception unit receiving sounds produced as reactions to the content item from neighborhood users when the content item is reproduced; and a transmission unit storing sound data of the sounds received by the sound reception unit in the UDP packets and transmitting the UDP packets to the server via the communication network.

The reaction sound data may be generated for each group formed by the plurality of users.

The transmission unit may transmit the sound data of the sound received by the sound reception unit when the amount of sound received by the sound reception unit is equal to or greater than a predetermined value.

The reaction sound data may be generated by adding the sound data subjected to the sound processing with a sufficiently small gain so that the sounds of the sound data subjected to the sound processing are not able to be distinguished from each other, when the reaction sounds are reproduced.

The transmission unit may transmit not only the sound data of the sounds received by the sound reception unit but also information regarding the content item. The server may generate the reaction sound data based on the sound data transmitted together with the information regarding the content item.

The transmission unit may transmit the sound data to the server specified by a URL determined in the content item.

The sound output unit may output sounds of the content item and the reaction sounds, when the content item is reproduced.

According to another embodiment of the disclosure, there is provided an information processing method or a program including controlling reproduction of a content item; receiving reaction sound data stored in UDP packets and transmitted from a server via a communication network when reproducing the content item, the server generating the reaction sound data of reaction sounds by receiving sound data obtained by receiving sounds produced as reactions to the content item from users from a plurality of apparatuses via the communication network, performing sound processing on the plurality of sound data received from the apparatuses based on positions of the users at a single virtual site and acoustic characteristics of the site, and adding the plurality of sound data subjected to the sound processing; and outputting the reaction sounds based on the received reaction sound data when the content item is reproduced.

According to still another embodiment of the disclosure, reproduction of a content item is controlled; reaction sound data stored in UDP packets and transmitted from a server via a communication network is received when reproducing the content item, the server generating the reaction sound data of reaction sounds by receiving sound data obtained by receiving sounds produced as reactions to the content item from users from a plurality of apparatuses via the communication network, performing sound processing on the plurality of sound data received from the apparatuses based on positions of the users at a single virtual site and acoustic characteristics of the site, and adding the plurality of sound data subjected to the sound processing; and the reaction sounds are output based on the received reaction sound data when the content item is reproduced.

According to still another embodiment of the disclosure, there is provided an information processing apparatus including: a reception unit receiving sound data via a communication network from apparatuses, which store the sound data obtained by receiving sounds produced as reactions to a content item from users in UDP packets and transmit the UDP packets, when the content item is reproduced; a sound processing unit performing sound processing on each of the sound data received from the plurality of apparatuses based on positions of the users at a single virtual site and acoustic characteristics of the site; an adding unit generating reaction sound data of reaction sounds by adding the plurality of sound data subjected to the sound processing; and a transmission unit storing the reaction sound data in the UDP packets and transmitting the UDP packets to the apparatuses via the communication network.

The adding unit may generate the reaction sound data by adding the sound data subjected to the different sound processing for each group formed by the plurality of users.

The adding unit may generate the reaction sound data by adding the sound data subjected to the sound processing with a sufficiently small gain so that the sounds of the sound data subjected to the sound processing are not able to be distinguished from each other, when the reaction sounds are reproduced.

According to still another embodiment of the disclosure, there is provided an information processing method or a program including receiving sound data via a communication network from apparatuses, which store the sound data obtained by receiving sounds produced as reactions to a content item from users in UDP packets and transmit the UDP packets, when the content item is reproduced; performing sound processing on each of the sound data received from the plurality of apparatuses based on positions of the users at a single virtual site and acoustic characteristics of the site; generating reaction sound data of reaction sounds by adding the plurality of sound data subjected to the sound processing; and storing the reaction sound data in the UDP packets and transmitting the UDP packets to the apparatuses via the communication network.

According to still another embodiment of the disclosure, sound data are received via a communication network from apparatuses, which store the sound data obtained by receiving sounds produced as reactions to a content item from users in UDP packets and transmit the UDP packets, when the content item is reproduced; sound processing is performed on each of the sound data received from the plurality of apparatuses based on positions of the users at a single virtual site and acoustic characteristics of the site; reaction sound data of reaction sounds are generated by adding the plurality of sound data subjected to the sound processing; and the reaction sound data are stored in the UDP packets and the UDP packets are transmitted to the apparatuses via the communication network.

According to still another embodiment of the disclosure, there is provided an information processing system including clients and a server connected to each other via a communication network. The client includes a reproduction control unit controlling reproduction of a content item, a sound reception unit receiving sounds produced as reactions to the content item from neighborhood users when the content item is reproduced, a first transmission unit storing sound data of the sounds received by the sound reception unit in UDP packets and transmitting the UDP packets via the communication network, a first reception unit receiving, from the server, reaction sound data of reaction sounds generated based on the sound data transmitted from the plurality of clients, and a sound output unit outputting the reaction sounds based on the received reaction sound data when the content item is reproduced. The server includes a second reception unit receiving the sound data transmitted from the other clients, a sound processing unit performing sound processing on each of the sound data transmitted from the plurality of clients based on positions of the users at a single virtual site and acoustic characteristics of the site, an adding unit generating the reaction sound data by adding the plurality of sound data subjected to the sound processing, and a second transmission unit storing the reaction sound data in UDP packets and transmitting the UDP packets to the clients via the communication network.

According to still another embodiment of the disclosure, a client controls reproduction of a content item, receives sounds produced as reactions to the content item from neighborhood users when the content item is reproduced, stores sound data of the sounds received by the sound reception unit in UDP packets and transmits the UDP packets via a communication network, receives, from the server, reaction sound data of reaction sounds generated based on the sound data transmitted from the plurality of other clients, and outputs the reaction sounds based on the received reaction sound data when the content item is reproduced. The server receives the sound data transmitted from the clients, performs sound processing on each of the sound data transmitted from the plurality of clients based on positions of the users at a single virtual site and acoustic characteristics of the site, generates the reaction sound data by adding the plurality of sound data subjected to the sound processing, and stores the reaction sound data in UDP packets and transmits the UDP packets to the clients via the communication network.

According to the embodiments of the disclosure, the reactions to the content item from many other users may be known irrespective of the content item.

### BRIEF DESCRIPTION OF THE DRAWINGS

FIG. 1 is a diagram of an example of the configuration of an information processing system according to an embodiment of the disclosure;

FIG. 2 is a diagram of an example of the configuration of a client;

FIG. 3 is a diagram of an example of the configuration of a server;

FIG. 4 is a flowchart of a reproduction process;

FIG. 5 is a flowchart of a delivery process;

FIG. 6 is a diagram of an impulse response;

FIG. 7 is a diagram of another example of the configuration of the client;

FIG. 8 is a diagram of still another example of the configuration of the client;

FIG. 9 is a diagram of another example of the configuration of the information processing system;

FIG. 10 is a diagram of still another example of the configuration of the information processing system;

FIG. 11 is a flowchart of a reproduction process;

FIG. 12 is a flowchart of a transmission process;

FIG. 13 is a flowchart of a delivery process; and

FIG. 14 is a diagram of an example of the configuration of a computer.

### DETAILED DESCRIPTION OF EMBODIMENTS

Hereinafter, embodiments of the disclosure will be described with reference to the drawings.

### First Embodiment

### Example of Configuration of Information Processing System

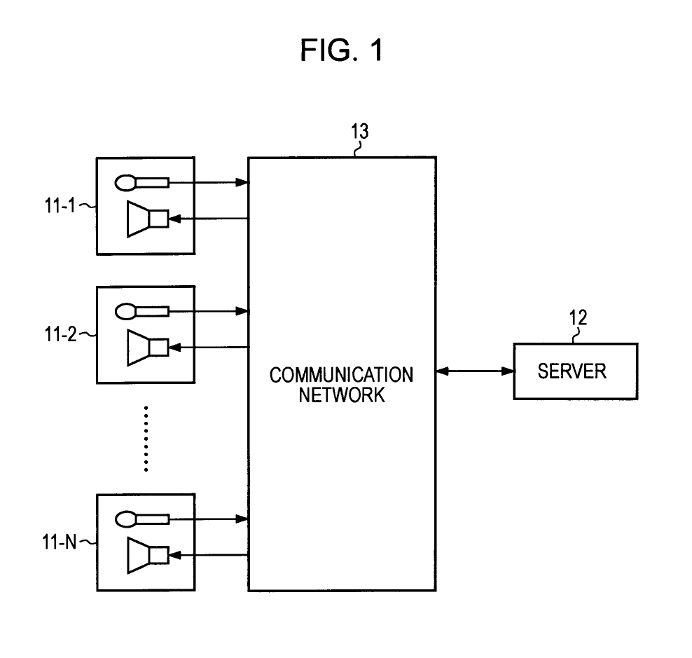

FIG. 1 is a diagram of an example of the configuration of an information processing system according to an embodiment of the disclosure. The information processing system includes clients 11-1 to 11-N, a server 12, and a communication network 13. The clients 11-1 to 11-N and the server 12 are connected to each other via the communication network 13 such as the Internet.

The clients 11-1 to 11-N include television receivers, mobile phones, and personal computers owned by respective users. The clients 11-1 to 11-N acquire and reproduce a content item, receive the sounds of the users watching the content item, and transmit the sounds of the users to the server 12.

When it is not necessary to distinguish the clients 11-1 to 11-N from each other, the clients 11-1 to 11-N are simply referred to as the clients 11. Further, content items reproduced by the clients 11 may be any content items such as television broadcast programs, Internet broadcast programs, and radio broadcast programs, as long as the content items can be simultaneously reproduced by the plurality of clients 11.

The server 12 receives sounds transmitted from the clients 11 and generates sounds (hereinafter, also referred to as reaction sounds) representing the reactions to the content item from the many users watching the same content item based on the received sounds. The server 12 transmits the generated reaction sounds to the respective clients 11 via the network 13.

For example, the server 12 assumes that the respective users watch one content item at the same place (hereinafter, also referred to as a virtual site) such as a virtual stadium and generates the reaction sounds from the sounds of the respective users by adding the positions or acoustic characteristics of the respective users in virtual sites. The reaction sounds are a collection of shouts of joy, laughs, cheers, and the like of a plurality of users such as hundreds or tens of thousands of users.

When the reaction sounds are transmitted from the server 12, the clients 11 receive and reproduce the reaction sounds. Thus, the users watching the content item through the clients 11 can know the reactions of the many other users in each scene of the content item, when watching the content item.

### Example of Configuration of Client

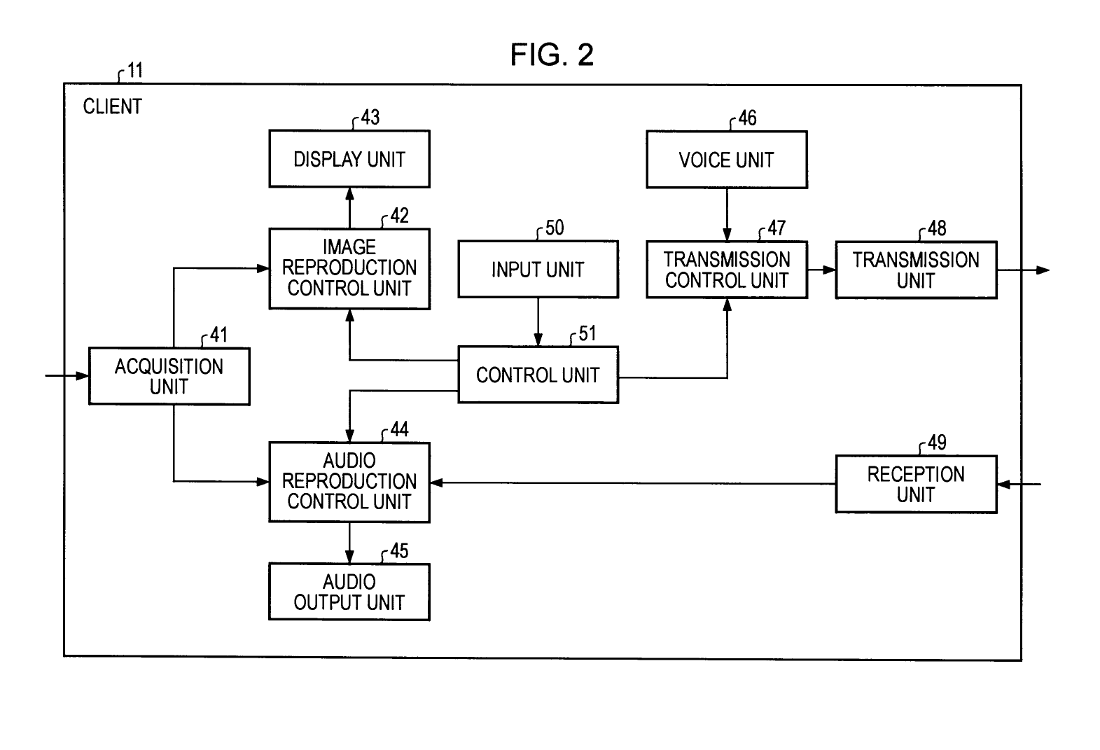

For example, the client 11 shown in FIG. 1 has a configuration shown in FIG. 2. The client 11 shown in FIG. 2 is, for example, a personal computer having a tuner therein or a television receiver.

The client 11 includes an acquisition unit 41, an image reproduction control unit 42, a display unit 43, a sound reproduction control unit 44, a sound output unit 45, a sound reception unit 46, a transmission control unit 47, a transmission unit 48, a reception unit 49, an input unit 50, and a control unit 51.

The acquisition unit 41 is configured by, for example, a tuner. The acquisition unit 41 acquires a content item being broadcast and supplies an image (image data) and a sound, which form the content item, to the image reproduction control unit 42 and the sound reproduction control unit 44, respectively.

The image reproduction control unit 42 performs processing such as decoding on the image supplied from the acquisition unit 41, if necessary, and supplies the processed image to the display unit 43. The display unit 43 is configured by, for example, a liquid crystal display. The display unit 43 displays the image supplied from the image reproduction control unit 42.

The sound reproduction control unit 44 performs processing such as decoding on the sound supplied from the acquisition unit 41, if necessary, and supplies the processed sound to the sound output unit 45. Further, when the reaction sound is supplied from the reception unit 49, the sound reproduction control unit 44 superimposes the reaction sound on the sound supplied from the acquisition unit 41 and supplies the superimposed sound to the sound output unit 45. The sound output unit 45 is configured by, for example, a speaker. The sound output unit 45 outputs the sound supplied from the sound reproduction control unit 44.

The sound reception unit 46 is configured by, for example, a microphone. The sound reception unit 46 receives sounds near the client 11 and supplies the received sounds (sound data) to the transmission control unit 47. The transmission control unit 47 performs processing such as encoding on the sound supplied from the sound reception unit 46, if necessary, and supplies the processed sound to the transmission unit 48. The transmission unit 48 transmits the sound supplied from the transmission control unit 47 to the server 12 via the communication network 13.

The reception unit 49 receives the reaction sound transmitted from the server 12 via the communication network 13 and supplies the received reaction sound to the sound reproduction control unit 44. The input unit 50 is configured by, for example, a unit receiving an infrared signal or a button. The input unit 50 supplies a signal corresponding to an operation of the user to the control unit 51. The control unit 51 controls the operations of the image reproduction control unit 42, the sound reproduction control unit 44, and the transmission control unit 47 in accordance with the signal from the input unit 50.

### Example of Configuration of Server

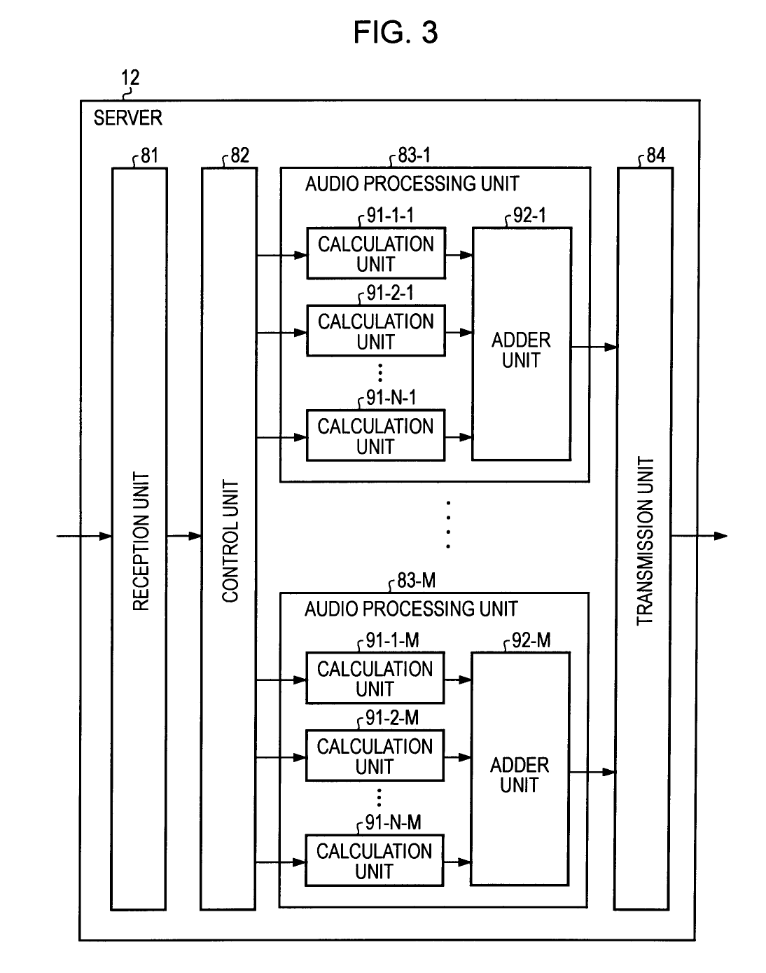

For example, the server 12 shown in FIG. 1 has a configuration shown in FIG. 3.

The server 12 includes a reception unit 81, a control unit 82, sound processing units 83-1 to 83-M, and a transmission unit 84.

The reception unit 81 receives the sounds transmitted from the clients 11 via the communication network 13 and supplies the sounds to the control unit 82. The control unit 82 supplies the sounds supplied from the reception unit 81 to the sound processing units 83-1 to 83-M.

The sound processing units 83-1 to 83-M generate the reaction sounds based on the sounds supplied from the control unit 82 and supply the generated sounds to the transmission unit 84.

For example, the sound processing unit 83-1 includes calculation units 91-1-1 to 91-N-1 and an adding unit 92-1. The sounds from the clients 11-1 to 11-N are supplied from the control unit 82 to the calculation units 91-1-1 to 91-N-1, respectively.

The calculation units 91-1-1 to 91-N-1 beforehand store impulse responses indicating the acoustic characteristics at any two positions of the virtual site, and thus perform convolution calculation on the sounds supplied from the control unit 82 by the use of the stored impulse responses. The calculation units 91-1-1 to 91-N-1 supply the sounds obtained through the convolution calculation to the adding unit 92-1.

The adding unit 92-1 adds the sounds supplied from the calculation units 91-1-1 to 91-N-1 and supplies a single sound obtained by adding the sounds as a reaction sound to the transmission unit 84.

Likewise, the sound processing unit 83-m (where 2≦m≦M) includes calculation units 91-1-m to 91-N-m and an adding unit 92-m. The calculation units 91-1-m to 91-N-m and the adding unit 92-m perform the same operations as those of the calculation units 91-1-1 to 91-N-1 and the adding unit 92-1.

When it is not necessary to distinguish the calculation units 91-n-m (where 1≦n≦N and 1≦m≦M) from each other, the calculation units 91-n-m are simply referred to as the calculation unit 91-n. Further, when it is not necessary to distinguish the calculation units 91-1 to 91-N from each other, the calculation units 91-1 to 91-N are simply referred to as the calculation units 91.

When it is not necessary to distinguish the adding units 92-1 to 92-M from each other, the adding units 92-1 to 92-M are simply referred to as the adding units 92. Further, when it is not necessary to distinguish the sound processing units 83-1 to 83-M from each other, the sound processing units 83-1 to 83-M are simply referred to as the sound processing units 83.

The transmission unit 84 transmits the reaction sounds supplied from the sound processing units 83 to the clients 11 via the communication network 13.

For example, it is assumed that N users watch the same content item and the server 12 includes the N sound processing units 83. That is, it is assumed that a relation of “M=N” is satisfied and the sounds are transmitted from the clients 11-1 to 11-N.

In this case, for example, the sound processing units 83-1 to 83-N generate the reaction sounds to be supplied to the clients 11-1 to 11-N based on the sounds from the clients 11, respectively. Then, the transmission unit 84 transmits the generated N reaction sounds to the clients 11-1 to 11-N, respectively. That is, in this example, the reaction sound is generated for each of the N clients 11.

### Description of Reproduction Process

When a user owning the client 11 gives an instruction to reproduce a content item by operating the client 11, the client 11 starts a reproduction process in response to the instruction and reproduces the content item designated by the user.

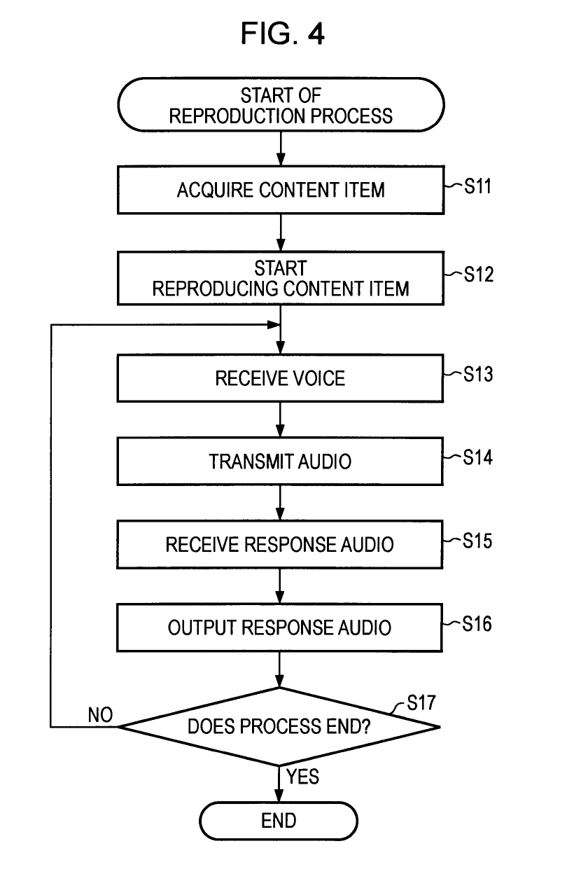

Hereinafter, the reproduction process performed by the client 11 will be described with the flowchart of FIG. 4.

In step S11, the acquisition unit 41 acquires the content item designated by the user. The acquisition unit 41 supplies image data forming the acquired content item to the image reproduction control unit 42 and supplies sound data forming the content item to the sound reproduction control unit 44. For example, data of a program broadcast for a television is acquired as the content item. The content item may be formed by one of an image and a sound.

In step S12, the client 11 starts reproducing the content item. Specifically, the image reproduction control unit 42 supplies the image data supplied from the acquisition unit 41 to the display unit 43 to allow the display unit 43 to display the image data. Further, the sound reproduction control unit 44 supplies the sound data supplied from the acquisition unit 41 to the sound output unit 45 to allow the sound output unit 45 to output the sound.

In this way, since the content item designated by the user is reproduced in the client 11, the user can watch the reproduced content item. Then, the user gives a reaction to the content item in each scene of the content item. For example, the user produces shouts of joy, laughs, or the like as the reaction. The sound of the reaction to the content item which is produced from the user reaches the sound reception unit 46.

In step S13, the sound reception unit 46 receives the sound produced from the user and supplies the sound data obtained based on the sound to the transmission control unit 47. The transmission control unit 47 supplies the sound data supplied from the sound reception unit 46 to the transmission unit 48.

The sound received by the sound reception unit 46 may be configured to be normally transmitted from the transmission unit 48 to the server 12 or may be configured to be transmitted only when a predetermined amount of sound is produced.

For example, when the sound of which an amount is equal to or greater than the predetermined amount of sound is transmitted, the transmission control unit 47 determines whether the amount of sound supplied from the sound reception unit 46 is equal to or greater than a predetermined threshold value. Only when the amount of sound is equal to or greater than the threshold value, the transmission control unit 47 supplies the sound from the sound reception unit 46 to the transmission unit 48 so as to transmit the sound to the server 12. For example, a sound with an interval closer to a nearly silent sound is not transmitted among the reaction sounds to the content item from the users.

When the reaction to the content item from the user is small and the amount of sound received by the sound reception unit 46 is small, it is possible to reduce the processing load of the client 11 or the server 12 by not transmitting the received sound to the server 12. Further, it is possible to suppress the unnecessary amount of traffic in the communication network 13.

In step S14, the transmission unit 48 transmits the sound data supplied from the transmission control unit 47 to the server 12 via the communication network 13.

For example, the transmission unit 48 transmits the sound data by storing the sound data of the user in UDP (User Datagram Protocol) packets. That is, the transmission unit 48 communicates with the server 12 in conformity with the UDP in a connectionless manner.

When the UDP is utilized as a communication protocol, the transmission delay of the sound can be suppressed and the load of the communication process can be reduced in comparison to the TCP (Transmission Control Protocol). Further, the UDP is lower than the TCP in reliability. However, when the reaction sounds are generated, the packets (sounds) transmitted to the server 12 may not be necessarily transmitted with high reliability in that the sounds of the individual users are not important and it is desirable not to distinguish the sounds of the respective users from each other.

In this way, when the sound data is transmitted from each client 11 to the server 12, the server 12 generates the sound data of the reaction sound using the sound data received from each client 11 and transmits the sound data to each client 11.

In step S15, the reception unit 49 receives the packets, in which the reaction sounds, more specifically, the sound data of the reaction sounds transmitted from the server 12 are stored, and supplies the packets to the sound generation control unit 44. For example, the reaction sounds are stored in the UDP packets and are transmitted from the server 12.

In step S16, the sound output unit 45 outputs the reaction sounds. That is, when the sound data of the reaction sounds are supplied from the reception unit 49, the sound reproduction control unit 44 appropriately performs processing such as decoding on the sound data.

The sound reproduction control unit 44 adds the sound data of the reaction sounds to the sound data of the content item supplied from the acquisition unit 41 and supplies the result to the sound output unit 45. The sound output unit 45 outputs the sounds based on the sound data supplied from the sound reproduction control unit 44. In this way, not only the sounds of the content items but also the reaction sounds, which are the reactions to the content item from the many other users, are output from the sound output unit 45.

Thus, since the reaction sounds of the many other users are output from the clients 11 during the reproduction of the content item, the users can know the reactions of the other users in real time while watching the content item.

In step S17, the client 11 determines whether the process ends. For example, when the user given an instruction to end the reproduction of the content item, the client 11 determines that the process ends. When the client 11 determines that the process does not end in step S17, the process returns to step S13 to reiterate the above-described processes. That is, the reproduction of the content item continues and the reaction sounds received from the server 12 are superimposed on the sounds of the content items for the reproduction.

On the other hand, when the client 11 determines that the process ends in step S17, the client 11 ends the communication with the server 12, stops the reproduction of the content item, and ends the reproduction process.

The client 11 reproduces the content item, receives the reaction sounds, which are the reaction of the content item from the many other users, from the server 12, and outputs both the sounds of the content item and the reaction sounds.

Thus, since the reactions of the content item from many other users can be announced to the users in real time irrespective of the reproduced content item, the users can feel that the users are watching the content item together with the many other users at the same place. Accordingly, since the users can share the feeling with the other users in each scene of the content item, the users can enjoy watching the content item.

For example, according to the information processing system, unknown users located at different places can watch the same content item and feel impressions of the same content item. By making the sounds of emotion, the respective users can hear the sounds of the many users shouting in the same scene and can thus share the impression.

As described above, the sounds produced as the reactions to the content item from the users are transmitted from the respective clients 11 to the server 12. However, it may be configured that the user can set whether the sounds of the users are transmitted to the server 12. In this case, for example, when the sounds are set not to be transmitted, the sounds of the users are not transmitted from the transmission unit 48 during the reproduction of the content item. However, the reaction sounds from the server 12 are received by the reception unit 49, so that both the content item and the reaction sounds are reproduced.

### Description of Delivery Process

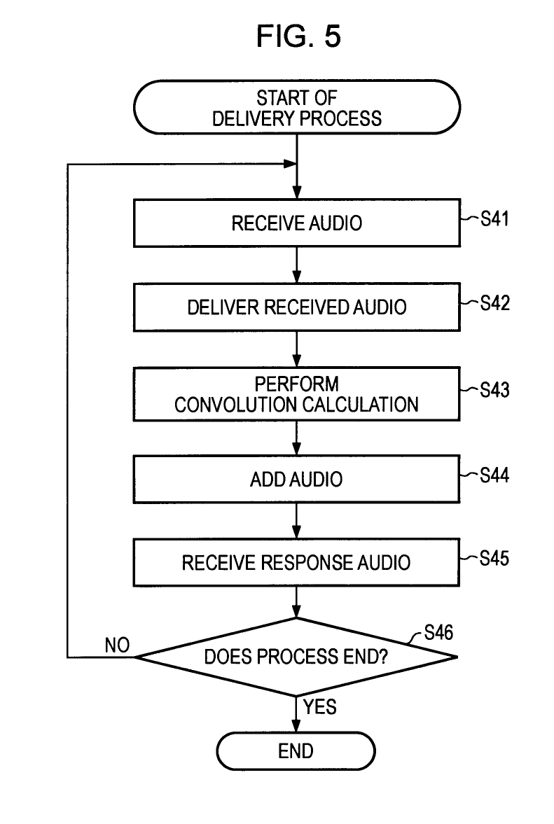

When the reproduction process in FIG. 4 is performed and the sounds are transmitted from the plurality of clients 11, the server 12 starts a delivery process of transmitting the reaction sounds to the respective clients 11. Hereinafter, the delivery process performed by the server 12 will be described with reference to the flowchart of FIG. 5.

In step S41, the reception unit 81 receives the sounds transmitted from the clients 11 via the communication network 13 and supplies the sounds to the control unit 82. In this way, the sounds received from the clients 11-1 to 11-N are supplied to the control unit 82.

In step S42, the control unit 82 performs processing such as decoding on the sounds supplied from the reception unit 81, if necessary, to distribute the sounds.

For example, it is assumed that the sounds are transmitted from the clients 11-1 to 11-N to the server 12 and the reaction sound is generated from each user (client 11). In this case, the sound processing units 83-1 to 83-N generate the reaction sounds to be transmitted to the clients 11-1 to 11-N, respectively. In this case, for example, the control unit 82 supplies the sounds from the clients 11-1 to 11-N to the calculation units 91-1 to 91-N of each sound processing unit 83, respectively. In step S43, the calculation units 91 perform convolution calculation using the beforehand stored impulse responses to the sounds (sound data) supplied from the control unit 82 and supply the result to the adding unit 92. In step S44, each adding unit 92 adds the sounds supplied from the calculation units 91-1 to 91-N, generates the sound data of the reaction sounds, and supplies the generated sound data to the transmission unit 84. Further, the adding unit 92 performs processing such as encoding on the sound data of the generated reaction sounds, if necessary.

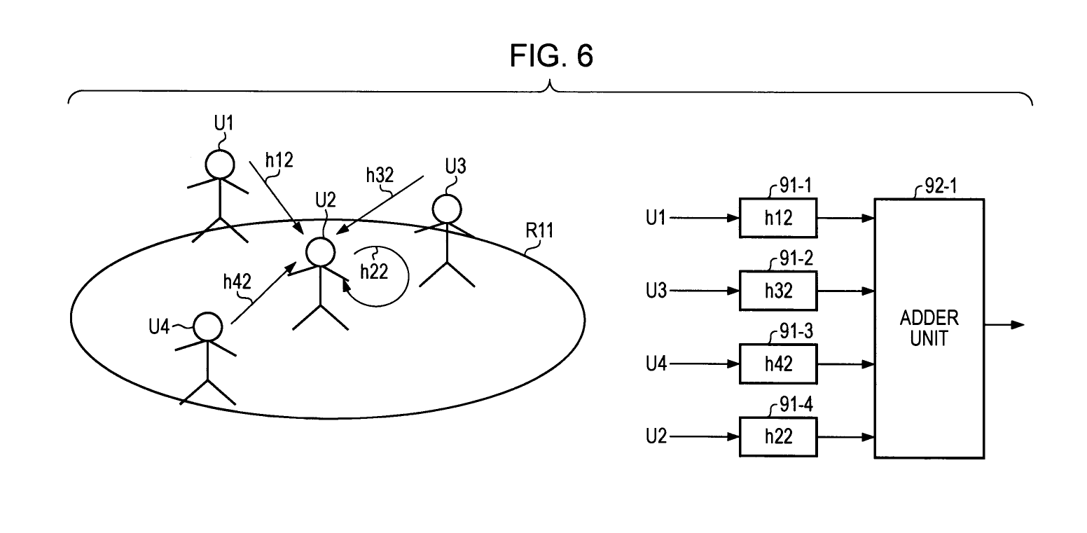

For example, as shown in the left part of FIG. 6, on the assumption that four users U1 to U4 are located at a virtual site R11, the sounds are transmitted from the clients 11-1 to 11-4 owned by the users U1 to U4 to the server 12.

In the example of FIG. 6, the user U2 is located in the middle of the virtual site R11 and the users U1, U3, and U4 are located so as to surround the user U2. In this case, the user U2 can hear the sounds produced from the users U1, U3, and U4 as well as the sound produced from the user U2 herself or himself.

Accordingly, the reaction sounds to be heard by the user U2 located at the virtual site R11 can be obtained by processing the sounds from the respective users in accordance with the acoustic characteristics between the positions of the respective users and the position of the user U2 and adding the respective processed sounds.

Here, it is assumed that h12 is an impulse response indicating the acoustic characteristic of the sound sent from the user U1 to the user U2 and h32 is an impulse response indicating the acoustic characteristic of the sound sent from the user U3 to the user U2. Further, it is assumed that h42 is an impulse response indicating the acoustic characteristic of the sound sent from the user U4 to the user U2 and h22 is an impulse response indicating the acoustic characteristic of the sound sent from the user U2 to the user U2 herself or himself.

As shown in the right side of FIG. 6, it is assumed that the impulse responses h12, h32, h42, and h22 are recorded in the calculation units 91-1 to 91-4, respectively. In this case, the sounds of the users U1, U3, U4, and U2, that is, the sound data transmitted from the clients 11 of the users are supplied to the calculation units 91-1 to 91-4, respectively.

Then, the calculation unit 91-1 convolutes the sound data of the user U1 with the impulse response h12 and supplies the sound data obtained as the result to the adding unit 92. Likewise, the calculation units 91-2 to 91-4 also convolute the sound data of the users U3, U4, and U2 with the impulse responses h32, h42 and h22 and supply the sound data obtained as the results to the adding unit 92, respectively.

The adding unit 92 generates the sound data of the reaction sounds transmitted to the client 11 of the user U2 by adding the sound data supplied from the calculation units 91-1 to 91-4. The reaction sounds are sounds of the respective users, such as the shouts of joy, heard by the user U2 located at the virtual site R11.

When the reaction sounds are generated, the sound data of the respective users are added with a gain sufficiently small to the extent that the sounds of the respective users may not be distinguished from each other. That is, when the reaction sounds are reproduced, the respective sound data are added with the sufficiently small gain so that the sounds of the users may not be distinguished from each other. This is because there are users saying undesirable words unsuitable to deliver to the other users among the users in some cases. In this way, the collection of the shouts of joy or laughs of many users can be obtained as the reaction sound by adding the sounds sufficiently small to the extent that the sounds of the individual users may not be distinguished.

Each sound processing unit 83 performs the sound processing on the sounds of the users in accordance with the acoustic characteristics determined depending on the positions of the users at the virtual site R11, adds the sounds subjected to the sound processing, and sets the sounds as the reaction sounds of the respective users.

For example, the positions of the respective users at the virtual site R11 are determined at random by the control unit 82. The control unit 82 supplies the sound data of the respective users to the calculation units 91 of each sound processing unit 83 in accordance with the determined positions of the respective users. Further, the calculation unit 91 may generate the impulse responses in accordance with the supplied positions of the users at the virtual site R11 so that the sounds of the users determined in advance are supplied to the respective calculation units 91.

Referring back to the flowchart of FIG. 5, the process proceeds from step S44 to step S45 when the reaction sounds to be transmitted to the respective users are generated and the sound data of the reaction sounds are supplied from the adding units 92 to the transmission unit 84.

In step S45, the transmission unit 84 transmits the sound data of the reaction sounds of the respective users supplied from the adding units 92 to the client 11 of the user. For example, the reaction sounds are stored in the UDP packets and are transmitted likewise when the sounds of the users are transmitted by the client 11.

In step S46, the server 12 determines whether the process ends. For example, when the broadcasting of the content item ends, the server 12 determines that the process ends.

When the server 12 determines that the process does not end in step S46, the process returns to step S41 and the above-described processes are reiterated. On the other hand, when the server 12 determines that the process ends in step S46, the delivery process ends.

In this way, the server 12 generates the reaction sounds which are the reactions to the content item from the many users by processing and adding the sounds transmitted from the respective clients 11 by the use of the acoustic characteristics in accordance with the positions of the users at the virtual site. Then, the server 12 transmits the generated reaction sounds to the respective clients 11.

Thus, since the reactions to the content item from the many other users can be delivered in real time to the users watching the content item, the users can feel as if the users are watching the content item at the same site at which the many other users are located. As a consequence, since the users can share the feelings at each scene of the content item together with the other users, the users can enjoy watching the content item.

The reaction sound is generated for each user, as described above, but the users may be divided into a plurality of groups and the reaction sound may be generated for each group. In this case, the reaction sound of the group to which the user belong is transmitted to the client 11 owned by this user.

For example, when the reaction sound is generated for each user, the convolution calculation of the sounds necessary to generate the reaction sounds of ten thousand users has to be performed ten thousand times on the assumption that there are ten thousand users watching the content item. Therefore, the convolution calculation of a total of ten thousand times×ten thousand times has to be performed in the server 12.

Accordingly, when the users are divided into the groups and the reaction sound is generated for each group or when the same impulse response is used for the respective users, the number of times of the calculation can be reduced in the server 12.

For example, when the virtual site is a concert hall in the dividing of the group of the users, the user may be divided into two groups of users in the first floor of the site and users in the second floor of the site.

In this case, the control unit 82 divides the users into the group of the users in the first floor of the site and the users of the second floor of the site based on information regarding the users at random or recorded in advance and generates the reaction sound for each group.

At this time, for example, the control unit 82 selects the positions of the seats of the users belonging to the first floor from the orchestra seats at random from the first floor and likewise selects the positions of the seats of the users belonging to the second floor from the balcony seats at random. Then, the control unit 82 distributes the sounds of the users to the respective calculation units 91 of the sound processing unit 83 in accordance with the positions of the seats of the respective users.

For example, each calculation unit 91 of the sound processing unit 83 generating the reaction sound of the first floor group performs sound convolution on the supplied sound of the user by the use of the impulse response indicating the acoustic characteristics from the position of the seat of this user to the position of a specific seat in the first floor. Then, the adding unit 92 adds the sound supplied from the respective calculation units 91 to set the reaction sound of the first floor group.

In effect, the reaction sounds of the first floor group obtained in this way are the sounds of the respective users heard by the user at a specific seat of the virtual site. However, the reaction sound is the reaction sound heard by the respective users in the first floor. The reaction sound is transmitted to the clients 11 of the respective users belonging to the first floor group.

As described above, the groups to which the users belong are determined by the control unit 82, but the user himself or herself may be configured to determine the group to which this user belongs.

In this case, for example, the user operates the input unit 50 of the client 11 and designates the position of the seat of the user himself or herself at the virtual site. For example, the user may designate the first floor or the second floor in a concert hall.

Then, the control unit 51 supplies information indicating the group designated by the user to the transmission control unit 47. For example, the information indicating the group may be information or the like indicating the first floor. The transmission control unit 47 adds the information indicating the group supplied from the control unit 51 to the sound data supplied from the sound reception unit 46 and supplies the result to the transmission unit 48.

The sound data to which the information indicating the group is added is transmitted to the server 12 in step S14 of FIG. 4. When the server 12 receives the sound data to which the information indicating the group is added, the control unit 82 divides the groups of the respective users based on the information added to the sound data and indicating the group. The information indicating the group may be transmitted separately from the sound data.

As another example of the dividing of the groups, when a program or the like, in which players are divided into a red team and a white team at an amateur singing contest, users can be divided into two groups: a group of users cheering the red team and a group of users cheering the white team. In this case, the reaction sound can be generated for the users belonging to the group of the white team so that the reaction sound of the users belonging to the group of the white team which is heard more loudly than the reaction sound of the users belonging to the group of the red team.

### Another Example 1 of Configuration of Client

As described above, for example, the client 11 has the configuration shown in FIG. 2. However, the client 11 may have any configuration as long as the client 11 can reproduce the content item and output the reaction sounds from the server 12.

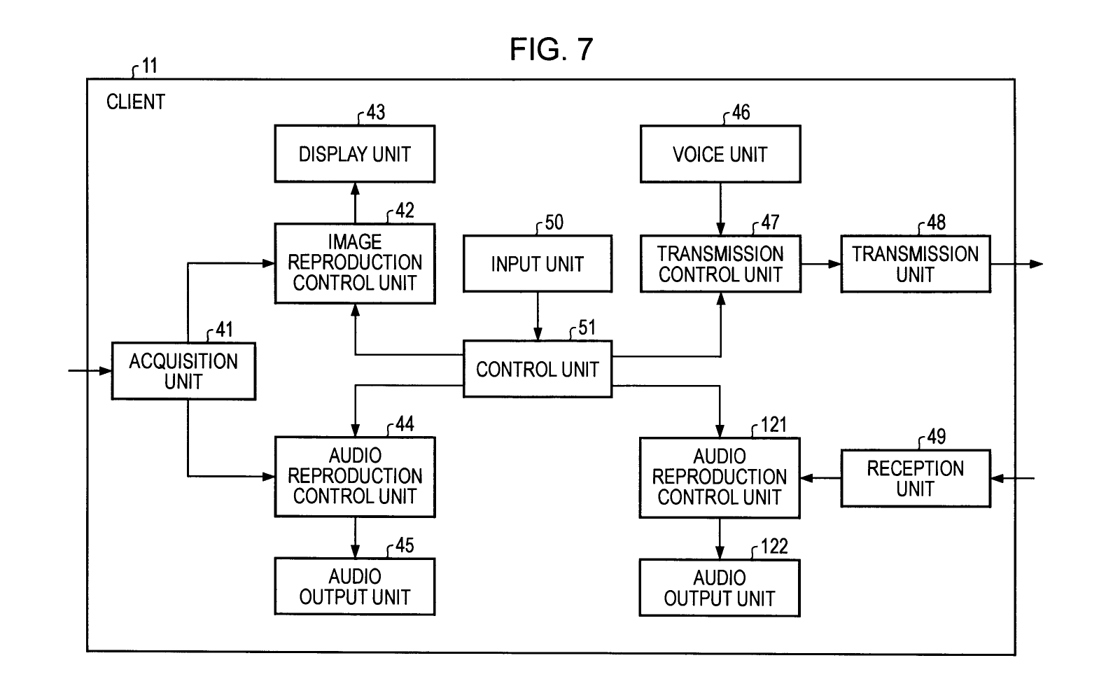

For example, the client 11 may have a configuration in which the sounds of the content item and the reaction sounds may be output from different sound output units, as shown in FIG. 7. In FIG. 7, the same reference numerals are given to the same constituent elements as those in FIG. 2 and the description thereof will not be appropriately repeated.

The client 11 shown in FIG. 7 is different from the client 11 shown in FIG. 2 in that a sound reproduction control unit 121 and a sound output unit 122 are further provided. The other configuration is the same as the configuration of the client 11 shown in FIG. 2.

In the client 11 shown in FIG. 7, the sound data of the reaction sounds received from the server 12 is supplied from the reception unit 49 to the sound reproduction control unit 121. The sound reproduction control unit 121 appropriately performs processing such as decoding on the sound data of the reaction sound under the control of the control unit 51 and supplies the processed sound data to the sound output unit 122. The sound output unit 122 includes, for example, a speaker, and thus outputs the reaction sound based on the sound data supplied from the sound reproduction control unit 121.

In this way, in the client 11 shown in FIG. 7, the sound of the content item is output from the sound output unit 45 and the reaction sound is output from the sound output unit 122.

### Another Example 2 of Configuration of Client

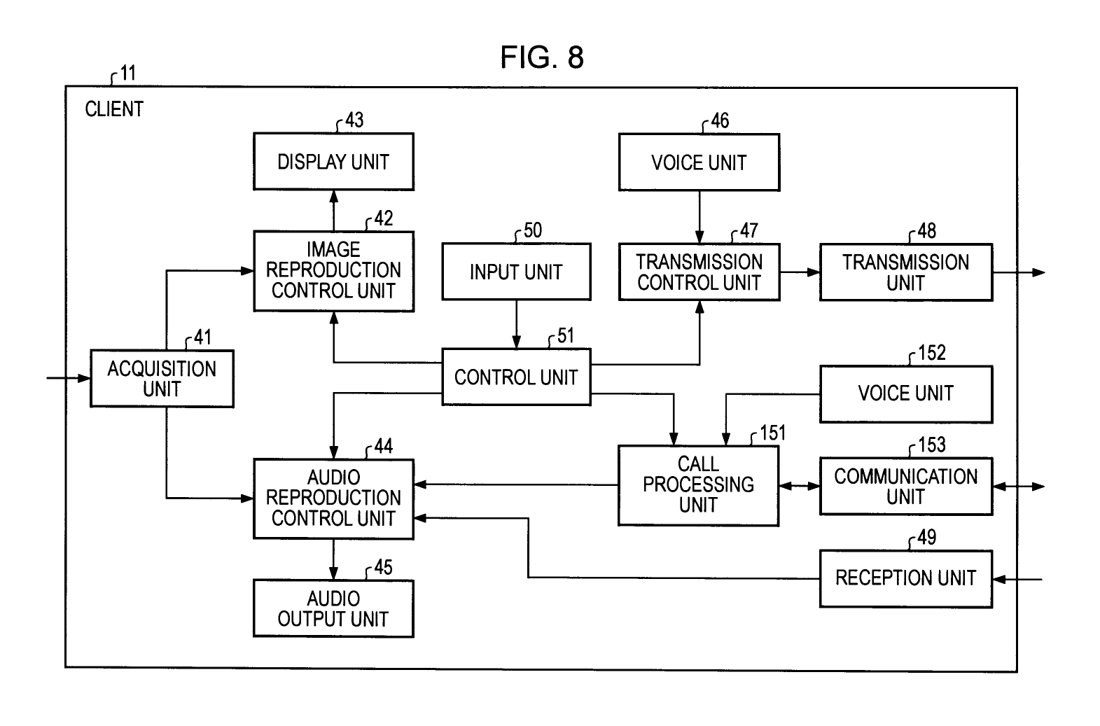

For example, the client 11 may have a configuration shown in FIG. 8. In FIG. 8, the same reference numerals are given to the same constituent elements as those in FIG. 2 and the description thereof will not be appropriately repeated.

The client 11 shown in FIG. 8 is different from the client 11 shown in FIG. 2 in that a call processing unit 151, a sound reception unit 152, and a communication unit 153 are further provided. The other configuration is the same as the configuration of the client 11 shown in FIG. 2.

The client 11 shown in FIG. 8 includes, for example, a mobile phone having a tuner therein, and thus performs call processing with another mobile phone via a communication network.

That is, when the user owning the client 11 gives a call, the sound reception unit 152 receives the call and supplies the obtained sound data to the call processing unit 151. The call processing unit 151 supplies the sound data from the sound reception unit 152 to the communication unit 153. The communication unit 153 transmits the sound data to the mobile phone of a call partner via the communication network.

The communication unit 153 receives the sound data transmitted from the mobile phone of the call partner and supplies the sound data to the call processing unit 151. The call processing unit 151 supplies the sound data supplied from the communication unit 153 to the sound output unit 45 via the sound reproduction control unit 44 and outputs the sound.

### Second Embodiment

### Example of Configuration of Information Processing System

In FIG. 1, the example has been described in which only one server 12 is connected to the communication network 13. However, a plurality of servers may be connected to the communication network 13.

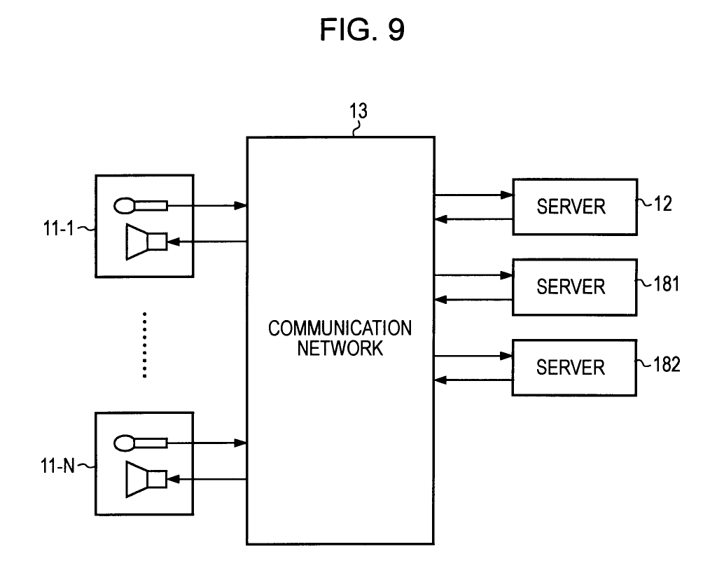

For example, as shown in FIG. 9, a server may be provided for each content item and the servers may be connected to the communication network 13. In FIG. 9, the same reference numerals are given to the same constituent elements as those in FIG. 1 and the description thereof will not be appropriately repeated.

In an information processing system shown in FIG. 9, the clients 11, a server 12, a server 181, and a sever 182 are connected to the communication network 13. The server 12, the server 181, and the server 182 generate the reaction sounds to different content items based on sounds received from the clients 11 and transmit the reaction sounds to the clients 11, respectively.

For example, a URL (Uniform Resource Locator) used to access one of the server 12, the server 181, and the server 182 is matched to each content item in advance. That is, among the server 12, the server 181, and the server 182, the server specified by the URL matched with the content item is a server which performs a process of generating the reaction sounds to this content item.

For example, the URL matched to each content item may be input directly through an operation of the input unit 50 by the user, or may be extracted from broadcast waves by the acquisition unit 41 and may be supplied to the control unit 51.

When the client 11 attempts to receive the reaction sounds to the content item during watching of the content item, the client 11 accesses the server specified by the URL matched with the content item among the server 12, the server 181, and the server 182. That is, the transmission control unit 47 controls the transmission unit 48 by an instruction from the control unit 51 and transmits the sounds received by the sound reception unit 46 to the server specified by the URL. Further, the reception unit 49 receives the reaction sounds from the server specified by the URL and supplies the reaction sounds to the sound output unit 45 via the sound reproduction control unit 44.

In this example, the reproduction process performed by the client 11 is performed as the reproduction process described with reference to FIG. 4 only when the access destination is determined by the URL. The servers 181 and 182 have the same configuration as that of the server 12 shown in FIG. 3. Accordingly, the server 12, the server 181, and the server 182 perform the process same as the delivery process described with reference to FIG. 5.

### Third Embodiment

### Example of Configuration of Information Processing System

The access to the specific server 12 or the like may not be gained by the URL, but the sounds from the clients 11 may be transmitted to the appropriate server 12 or the like by a content item ID used to specify the content item.

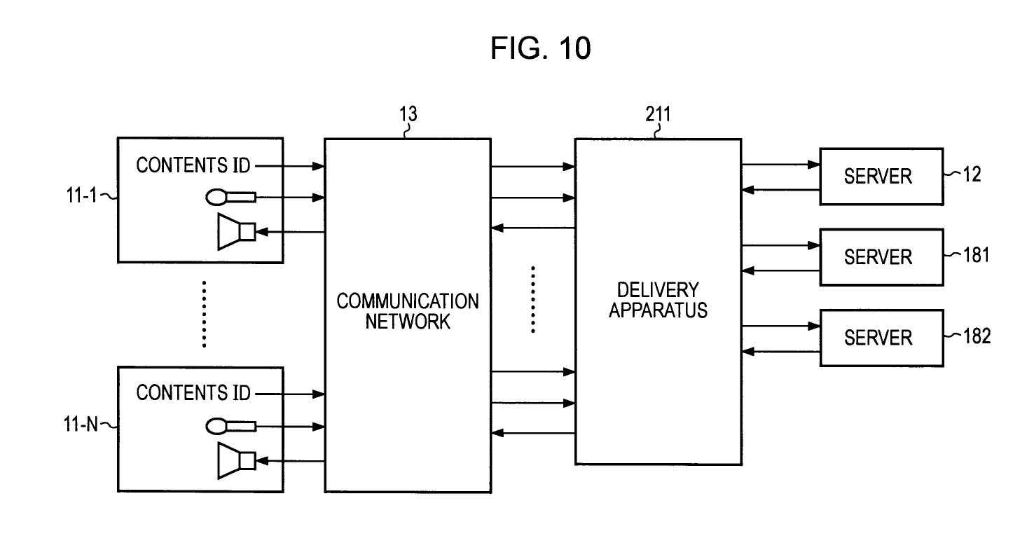

In this case, for example, the information processing system has a configuration shown in FIG. 10. In FIG. 10, the same reference numerals are given to the same constituent elements as those in FIG. 9 and the description thereof will not be appropriately repeated.

In the information processing system shown in FIG. 10, the clients 11 and a distribution apparatus 211 are connected to the communication network 13. Further, the server 12, the server 181, and the server 182 are connected to the distribution apparatus 211.

In this example, the respective clients 11 transmit both the sounds obtained by receiving the reactions to the content item from the users and the content item ID used to specify the content item to the distribution apparatus 211. For example, the content item ID may be a channel number or the like of a television broadcast.

The distribution apparatus 211 records the content item ID of the content item and information indicating the server generating the reaction sounds of the content item in correspondence with the content item ID and the information and functions as a switch. That is, when the sounds and the content item ID are transmitted from the clients 11, the distribution apparatus 211 receives the sounds and the content item ID and transmits the sounds from the clients 11 to the server specified by the received content item ID among the server 12, the server 181, and the server 182.

The distribution apparatus 211 receives the reaction sounds to the respective content items transmitted from the server 12, the server 181, and the server 182 and transmits the reaction sounds to the clients 11 transmitting the content item IDs of the content items, respectively.

### Description of Reproduction Process

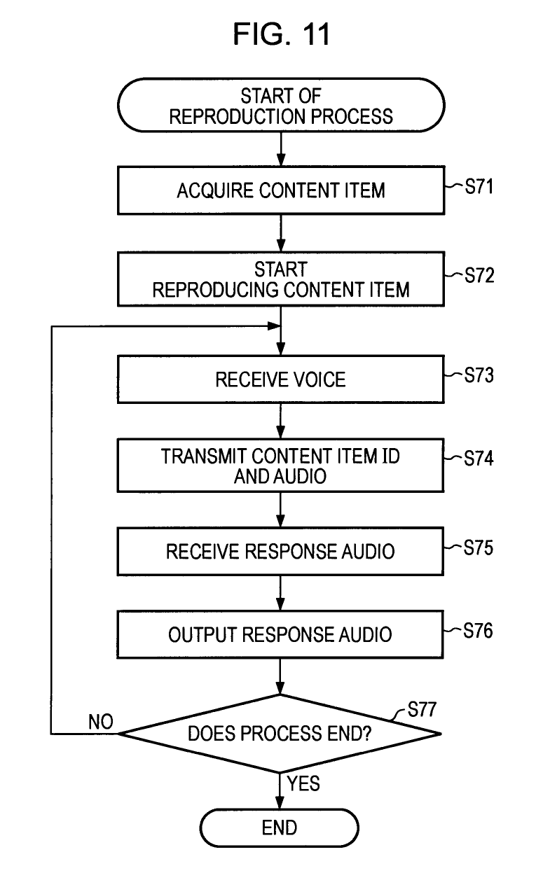

Next, processes performed by each of the apparatuses of the information processing system shown in FIG. 10 will be described. First, a reproduction process performed by the client 11 shown in FIG. 2 will be described with reference to the flowchart of FIG. 11. The processes from step S71 to S73 are the same as the processes from step S11 to step S13 of FIG. 4, and thus the description thereof will not be repeated.

In step S74, the transmission unit 48 stores the content item ID and the sounds supplied from the transmission control unit 47 in UDP packets and transmits the UDP packets to the distribution apparatus 211 via the communication network 13.

For example, the content item ID to be transmitted to the distribution apparatus 211 is input through an operation of the input unit 50 or is extracted from the broadcast waves of the content item by the acquisition unit 41. The control unit 51 acquires, from the input unit 50 or the acquisition unit 41, the content item ID of the content item which the users are watching and supplies the content item ID to the transmission control unit 47.

The transmission control unit 47 supplies the transmission unit 48 with both the content item ID supplied from the control unit 51 and the sounds from the sound reception unit 46. The content item ID may be added to the sounds received by the sound reception unit 46.

When the content item ID and the sounds are transmitted from the clients 11, the content item ID and the sounds are transmitted to one of the server 12, the server 181, and the server 182 by the distribution apparatus 211. The reaction sounds to the content item are generated in accordance with the transmission destination of the content item ID and the sounds and the reaction sounds are transmitted to the clients 11 via the distribution apparatus 211.

In step S75, the reception unit 49 receives the reaction sounds transmitted from the distribution apparatus 211 and supplies the sound reproduction control unit 44. Thereafter, the processes of step S76 and step S77 are performed and the reproduction process ends. These processes are the same as those of step S16 and step S17, and thus the description thereof will not be repeated.

### Description of Transmission Process

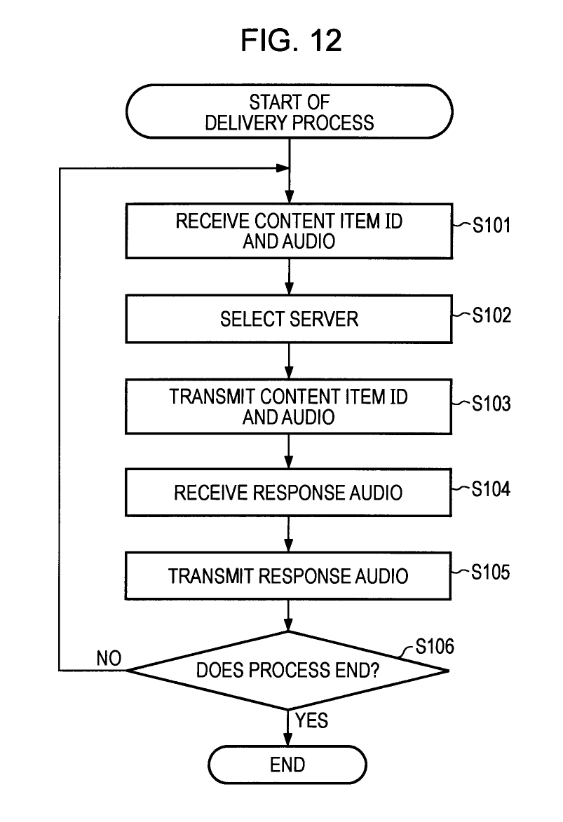

Next, the transmission process performed by the distribution apparatus 211 shown in FIG. 10 will be described with reference to the flowchart of FIG. 12.

In step S101, the distribution apparatus 211 receives the content item ID and the sounds transmitted from the clients 11. In step S102, the distribution apparatus 211 selects the server specified by the received content item ID among the server 12, the server 181, and the server 182.

In step S103, the distribution apparatus 211 transmits the content item ID and the sounds received from the clients 11 to the server selected in step S102. Thus, the sounds from the clients 11 reproducing the same content item are transmitted to the same server.

When the content item ID and the sounds are transmitted to the server 12 or the like, the server 12 or the like receiving the content item ID and the sounds generates the reaction sounds based on the received sounds and transmits the generated reaction sounds to the distribution apparatus 211.

In step S104, the distribution apparatus 211 receives the reaction sounds transmitted from the server 12 or the like. In step 5105, the distribution apparatus 211 stores the received reaction sounds in the UDP packets and transmits the UDP packets to the clients 11 via the communication network 13. For example, the reaction sounds received from the server 12 are transmitted to the clients 11 transmitting the content item ID matched with the server 12.

In step 5106, the distribution apparatus 211 determines whether the process ends. For example, when the broadcast of the content item ends, distribution apparatus 211 determines that the process ends.

When the distribution apparatus 211 determines that the process does not end in step 5106, the process returns to step 5101 and the above-described processes are reiterated. On the other hand, when the distribution apparatus 211 determines that the process ends in step 5106, the transmission process ends.

In this way, the distribution apparatus 211 transmits the sounds transmitted from the respective clients 11 to the server specified by the content item ID transmitted together with the sounds and transmits, to the clients 11, the reaction sounds transmitted from the server in response to the transmission of the sounds. Accordingly, when the reaction sounds of the different content items are generated by the plurality of servers, the reactions sounds to the different content items can be prevented from coexisting in one reaction sound.

### Description of Delivery Process

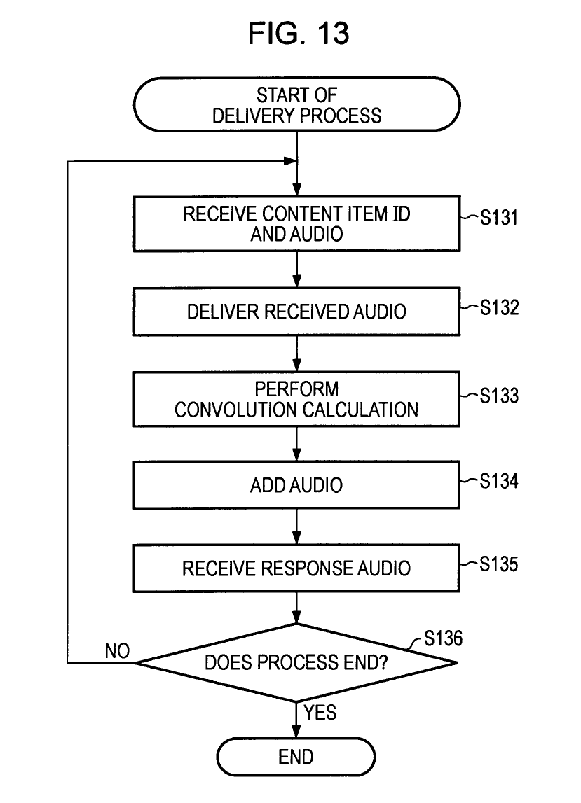

Next, the delivery process performed by the server 12 shown in FIG. 10 will be described with reference to the flowchart of FIG. 13.

In step S131, the reception unit 81 receives the content item ID and the sounds transmitted from the distribution apparatus 211 and supplies the content item ID and the sounds to the control unit 82. Thereafter, the processes from step S132 to step S134 are performed to generate the reaction sounds of the content item. These processes are the same as the processes of step S42 to step S44 in FIG. 5, and thus the description thereof will not be repeated.

In step S135, the transmission unit 84 transmits the reaction sounds supplied from the adding unit 92 to the distribution apparatus 211. Thereafter, the process of step S136 is performed and the delivery process ends. The process of step S136 is the same as the process of step S46 in FIG. 5, and thus the description thereof will not be repeated.

In this way, the server 12 generates the reaction sounds based on the sounds transmitted from the distribution apparatus 211. The server 181 and the server 182 shown in FIG. 10 perform the same delivery process as that described with reference to FIG. 13.

As described above, one reaction sound is generated by one server (for example, the server 12). However, one reaction sound may be generated by the plurality of servers.

In this case, for example, a plurality of sub-servers is connected to the server generating the final reaction sounds. The sub-servers receive the sounds from the plurality of clients 11, generate temporary reaction sounds, and transmit the temporary reaction sounds to the server. Then, the server generates the final reaction sounds by adding the temporary reaction sounds received from the plurality of sub-servers and transmits the reaction sounds to the respective sub-server. Further, the sub-servers transmit the reaction sounds received from the server to the respective clients 11.

When the reaction sounds are generated by the plurality of sub-servers and the server, the reaction sounds can be generated more rapidly, thereby reducing the delay of the reaction sounds to the content item. Further, there may be provided a sub-server which receives the temporary reaction sounds from several sub-servers, adds the temporary reaction sounds, and transmits the temporary reaction sounds obtained as a result to the server.

The above-described series of processes may be executed by hardware or software. When the series of processes are executed by software, a program forming the software is installed in, for example, a computer embedded with dedicated hardware or a general personal computer which can execute various functions by installing various programs from a program recording medium.

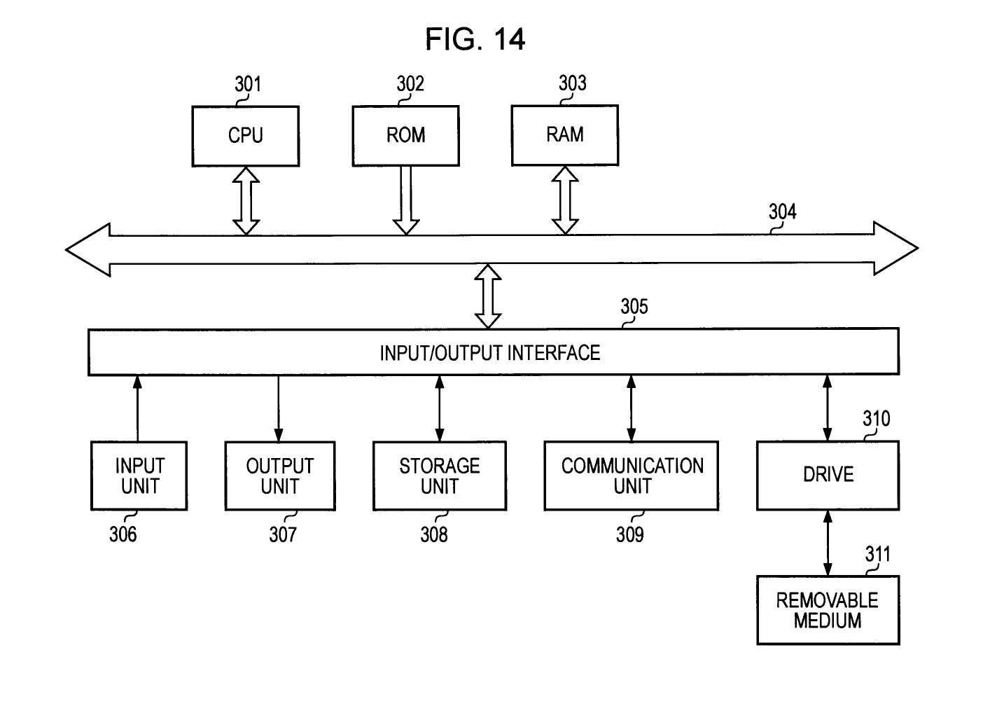

FIG. 14 is a block diagram of an example of the hardware configuration of a computer executing the above-described series of processes in accordance with a program.

In the computer, a CPU 301, a ROM (Read Only Memory) 302, and a RAM (Random Access Memory) 303 are connected to each other via a bus 304.

Further, an input/output interface 305 is connected to the bus 304. An input unit 306 configured by a keyboard, a mouse, a microphone, or the like, an output unit 307 configured by a display, a speaker, or the like, a storage unit 308 configured by a hard disk, a non-volatile memory, or the like, a communication unit 309 configured by a network interface, and a drive 310 driving a removable medium 311 such as a magnetic disk, an optical disc, a magneto-optical disc, a semiconductor memory, or the like are connected to the input/output interface 305.

For example, in the computer having the above-described configuration, the above-described series of processes may be executed by loading and executing a program stored in the storage unit 308 on the RAM 303 via the input/output interface 305 and the bus 304 by the CPU 301.

The program executed by the computer (the CPU 301) is stored in the removable medium 311 which is a packet medium for a magnetic disk (including a flexible disk), an optical disc (including a CD-ROM (Compact Disc-Read Only Memory) and a DVD (Digital Versatile Disc)), a magneto-optical disc, or a semiconductor memory or is supplied via a wired or wireless transmission medium such as a local area network, the Internet, or digital satellite broadcasting.

The program can be installed in the storage unit 308 via the input/output interface 305 by loading the removable medium 311 in the drive 310. Further, the program can be received via a wired or wireless transmission medium by the communication unit 309 and can be installed in the storage unit 308. Otherwise, the program can be installed in advance in the ROM 302 or the storage unit 308.

The program executed by the computer may be a program executed chronologically in the order described in the specification or may be a program executed in parallel or at a necessary time when called.

The present disclosure contains subject matter related to that disclosed in Japanese Priority Patent Application JP 2010-279510 filed in the Japan Patent Office on Dec. 15, 2010, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing apparatus comprising:
a reproduction control unit controlling reproduction of a content item;
a reception unit receiving reaction sound data stored in UDP packets and transmitted from a server via a communication network when reproducing the content item, the server generating the reaction sound data of reaction sounds by receiving sound data obtained by receiving sounds produced as reactions to the content item from users from a plurality of apparatuses via the communication network, performing sound processing on the plurality of sound data received from the apparatuses based on positions of the users at a single virtual site and acoustic characteristics of the site, and adding the plurality of sound data subjected to the sound processing; and
a sound output unit outputting the reaction sounds based on the received reaction sound data when the content item is reproduced.

2. The information processing apparatus according to claim 1, further comprising:
a sound reception unit receiving sounds produced as reactions to the content item from neighborhood users when the content item is reproduced; and
a transmission unit storing sound data of the sounds received by the sound reception unit in the UDP packets and transmitting the UDP packets to the server via the communication network.

3. The information processing apparatus according to claim 2, wherein the reaction sound data is generated for each group formed by the plurality of users.

4. The information processing apparatus according to claim 2, wherein the transmission unit transmits the sound data of the sound received by the sound reception unit when the amount of sound received by the sound reception unit is equal to or greater than a predetermined value.

5. The information processing apparatus according to claim 2, wherein the reaction sound data is generated by adding the sound data subjected to the sound processing with a sufficiently small gain so that the sounds of the sound data subjected to the sound processing are not able to be distinguished from each other, when the reaction sounds are reproduced.

6. The information processing apparatus according to claim 2,
wherein the transmission unit transmits not only the sound data of the sounds received by the sound reception unit but also information regarding the content item, and
wherein the server generates the reaction sound data based on the sound data transmitted together with the information regarding the content item.

7. The information processing apparatus according to claim 2, wherein the transmission unit transmits the sound data to the server specified by a URL determined in the content item.

8. The information processing apparatus according to claim 2, wherein the sound output unit outputs sounds of the content item and the reaction sounds, when the content item is reproduced.

9. An information processing method of an information processing apparatus, which includes a reproduction control unit controlling reproduction of a content item, a reception unit receiving reaction sound data stored in UDP packets and transmitted from a server via a communication network when reproducing the content item, the server generating the reaction sound data of reaction sounds by receiving sound data obtained by receiving sounds produced as reactions to the content item from users from a plurality of apparatuses via the communication network, performing sound processing on the plurality of sound data received from the apparatuses based on positions of the users at a single virtual site and acoustic characteristics of the site, and adding the plurality of sound data subjected to the sound processing, and a sound output unit outputting the reaction sounds based on the received reaction sound data when the content item is reproduced, the information processing method comprising:
controlling the content item by the reproduction control unit;
receiving the reaction sound data by the reception unit; and
outputting the reaction sounds by the sound output unit.

10. A program causing a computer to execute:
controlling reproduction of a content item;
receiving reaction sound data stored in UDP packets and transmitted from a server via a communication network when reproducing the content item, the server generating the reaction sound data of reaction sounds by receiving sound data obtained by receiving sounds produced as reactions to the content item from users from a plurality of apparatuses via the communication network, performing sound processing on the plurality of sound data received from the apparatuses based on positions of the users at a single virtual site and acoustic characteristics of the site, and adding the plurality of sound data subjected to the sound processing; and
outputting the reaction sounds based on the received reaction sound data when the content item is reproduced.

11. An information processing apparatus comprising:
a reception unit receiving sound data via a communication network from apparatuses, which store the sound data obtained by receiving sounds produced as reactions to a content item from users in UDP packets and transmit the UDP packets, when the content item is reproduced;
a sound processing unit performing sound processing on each of the sound data received from the plurality of apparatuses based on positions of the users at a single virtual site and acoustic characteristics of the site;
an adding unit generating reaction sound data of reaction sounds by adding the plurality of sound data subjected to the sound processing; and
a transmission unit storing the reaction sound data in the UDP packets and transmitting the UDP packets to the apparatuses via the communication network.

12. The information processing apparatus according to claim 11, wherein the adding unit generates the reaction sound data by adding the sound data subjected to the different sound processing for each group formed by the plurality of users.

13. The information processing apparatus according to claim 11, wherein the adding unit generates the reaction sound data by adding the sound data subjected to the sound processing with a sufficiently small gain so that the sounds of the sound data subjected to the sound processing are not able to be distinguished from each other, when the reaction sounds are reproduced.

14. An information processing method of an information processing apparatus which includes a reception unit receiving sound data via a communication network from apparatuses, which store the sound data obtained by receiving sounds produced as reactions to a content item from users in UDP packets and transmit the UDP packets, when the content item is reproduced, a sound processing unit performing sound processing on each of the sound data received from the plurality of apparatuses based on positions of the users at a single virtual site and acoustic characteristics of the site, an adding unit generating reaction sound data of reaction sounds by adding the plurality of sound data subjected to the sound processing; and a transmission unit storing the reaction sound data in the UDP packets and transmitting the UDP packets to the apparatuses via the communication network, the information processing method comprising:
receiving the sound data by the reception unit;
performing the sound processing on the sound data by the sound processing unit;
generating the reaction sound data by the adding unit; and
transmitting the reaction sound data by the transmission unit.

15. A program causing a computer to execute:
receiving sound data via a communication network from apparatuses, which store the sound data obtained by receiving sounds produced as reactions to a content item from users in UDP packets and transmit the UDP packets, when the content item is reproduced;
performing sound processing on each of the sound data received from the plurality of apparatuses based on positions of the users at a single virtual site and acoustic characteristics of the site;
generating reaction sound data of reaction sounds by adding the plurality of sound data subjected to the sound processing; and
storing the reaction sound data in the UDP packets and transmitting the UDP packets to the apparatuses via the communication network.

16. An information processing system comprising:
clients and a server connected to each other via a communication network,
wherein the client includes
a reproduction control unit controlling reproduction of a content item,
a sound reception unit receiving sounds produced as reactions to the content item from neighborhood users when the content item is reproduced,
a first transmission unit storing sound data of the sounds received by the sound reception unit in UDP packets and transmitting the UDP packets via the communication network,
a first reception unit receiving, from the server, reaction sound data of reaction sounds generated based on the sound data transmitted from the plurality of other clients, and
a sound output unit outputting the reaction sounds based on the received reaction sound data when the content item is reproduced, and
wherein the server includes
a second reception unit receiving the sound data transmitted from the clients,
a sound processing unit performing sound processing on each of the sound data transmitted from the plurality of clients based on positions of the users at a single virtual site and acoustic characteristics of the site,
an adding unit generating the reaction sound data by adding the plurality of sound data subjected to the sound processing, and
a second transmission unit storing the reaction sound data in UDP packets and transmitting the UDP packets to the clients via the communication network.
